(19) United States
(12) Patent Application Publication
(10) Pub. No.: US 2008/0210538 A1
(43) Pub. Date: Sep. 4, 2008

(54) Pyrolysis System

(75) Inventor: Allan Clark, Carmarthenshire (GB)

Correspondence Address: PATENT LAW GROUP LLP, 2635 NORTH FIRST STREET, SUITE 223, SAN JOSE, CA, 95134, US

(73) Assignee: ITEM TECHNOLOGY SOLUTIONS LTD., Rhondda Cynon Taff (GB)

(21) Appl. No.: 11/995,410

(22) PCT Filed: Jul. 10, 2006
(86) PCT No.: PCT/GB06/02541

§ 371 Date: Feb. 6, 2008

(30) Foreign Application Priority Data
Jul. 12, 2005 (GB) 0514282.3

(51) Int. Cl. C10B 1/10; F27B 7/24

(52) U.S. Cl. 202/131; 202/218; 202/242; 202/262; 432/115

(57) ABSTRACT

A system (10) for pyrolysing material comprises a stationary inlet stage (20), a rotary kiln (60) and a stationary outlet stage (70), with a rotary joint mechanism (30, 80) provided between the inlet stage (20) and the rotary kiln and/or between the rotary kiln and the outlet stage (70). The rotary joint mechanism (30, 80) comprises a face seal between a rotating surface (66) of a first seal member (65, 85) fixed to the kiln (60) and a stationary surface (26) of a second seal member (25, 82) fixed to the respective stage (20, 70).

The present invention relates to a system for undertaking a pyrolysis process, in particular the pyrolysis of materials containing volatile components.

In known pyrolysis processes using an indirectly heated rotary kiln, the material to be processed is passed into one end of the kiln. The kiln is usually set on rollers and is at a slight incline to the horizontal. The feed material is fed into higher end of the kiln. It passes through the rotating drum of the kiln and the non-volatile portion passes out at the lower end. Heat generated in a furnace surrounding the kiln provides the energy required for the pyrolysis. The kiln has a steel wall which is heated to a predetermined temperature and the heat passes by conduction through the steelwork and hence into the material to be pyrolysed.

In these pyrolysis processes it is necessary to keep air out of the vessel, otherwise the pyrolysis gases could explode. Moreover, the pyrolysis gases produced should not be allowed to escape from the vessel and cause pollution to the atmosphere.

Most conventional rotary kilns have mechanical sealing devices at both the inlet and outlet ends to prevent air ingress into the kiln and blowing out of gases from the kiln. However, existing seals are relatively complex and expensive to produce and it is difficult to maintain a permanent seal of the required high standard.

GB 1 240 238 discloses apparatus for sealing the joint between a stationary part and a rotary part of a kiln. With this sealing device the rotary kiln atmosphere lies adjacent to the seal on the kiln side. The seal is therefore exposed to the atmosphere inside the kiln, which contains dust and/or corrosive materials that could damage the seal and contribute to a reduction in efficiency. This could cause gases to escape from inside the kiln to the environment.

Aspects of the present invention seek to overcome or reduce the above problems.

According to a first aspect of the present invention there is provided a system for pyrolysing material comprising a stationary inlet stage, a rotary kiln and a stationary outlet stage, the inlet stage being upstream of the kiln, the kiln being upstream of the outlet stage, wherein there is provided between the inlet stage and the rotary kiln and/or between the rotary kiln and the outlet stage a rotary joint mechanism comprising a face seal between a rotating surface of a first seal member fixed to the kiln and a stationary surface of a second seal member fixed to the respective stage.

In a preferred embodiment the sealing surfaces of the first and second seal members are annular.

The seal members are preferably attached to respective inlet and outlet pipes of the rotary joint mechanism. It will be noted that the inlet stage is upstream of the kiln and that the kiln is upstream of the outlet stage. It will be also noted that the outlet stage is downstream of the kiln and that the kiln is downstream of the inlet stage. In preferred arrangements the upstream device comprises an outlet pipe which extends through an inlet pipe of larger diameter of the downstream device. Most preferably, said outlet pipe extends into the downstream device itself, which has the advantage of directing the conveyed material away from the respective rotary joint mechanism.

The rotary joint mechanism may incorporate a passageway for the introduction of an inert purging gas to prevent entry of air into the system and/or to prevent gases from leaving the system. The passageway preferably extends to the sealing surface of the stationary seal member from another surface of the stationary seal member, preferably from an outer cylindrical surface thereof.

To cater for solid materials to be pyrolysed which are not substantially plastic, the inlet stage may be provided with a valve mechanism to constitute an inlet seal. The valve may be a rotary valve or a double flap valve or other mechanical sealing device.

Alternatively, to cater for liquids or slurry materials to be pyrolysed, the inlet seal is achieved by means of a pump connected to a feed pipe.

The outlet side of the system preferably comprises a filter for dust-laden gases leaving the kiln, the filtered gases passing to a gas outlet. Solids emerging from the kiln pass from an outlet receptacle or drop out box to a conveying device. A valve, such as a rotary valve or a double flap valve, may be provided between the container and the conveying device to serve as an outlet seal. Alternatively, the seal can be made by maintaining a column of material between the container (e.g. a drop out box) and the conveying device.

According to a second aspect of the present invention there is provided a pyrolysis process comprising feeding a material to be pyrolysed to the inlet side of a first rotary joint mechanism incorporating an inlet sealing arrangement, passing the material through the first rotary joint mechanism into a rotary kiln, pyrolysing the material in the rotary kiln, and passing the material through a second rotary joint mechanism incorporating an outlet sealing arrangement to the outlet side thereof.

The system used in the process is preferably in accordance with the first aspect of the present invention.

For substantially non-plastic solid materials to be pyrolysed, the feeding step includes feeding the material through a valve mechanism such as a rotary valve or double flap valve as an inlet seal.

For liquid or slurry materials to be pyrolysed, the feeding step includes using pumping means to feed the material through the first rotary joint mechanism, the pumping means acting as an inlet seal.

For substantially plastic materials to be pyrolysed, the feeding step comprises using delivery means to feed the material through the first rotary joint mechanism to form a plug of material which acts as an input seal. This arrangement may be employed for compactable, plastic or semi-plastic materials. The delivery means may be a compressor screw, a hydraulic ramming device, or an extrusion device in the inlet pipe.

The process may also include the step of purging the rotary joint mechanisms with an inert gas such as nitrogen.

At the outlet, the process may also include the step of filtering dust-laden gases emerging from the kiln.

A preferred embodiment of the present invention will now be described, by way of example only, with reference to the accompanying drawings, of which:

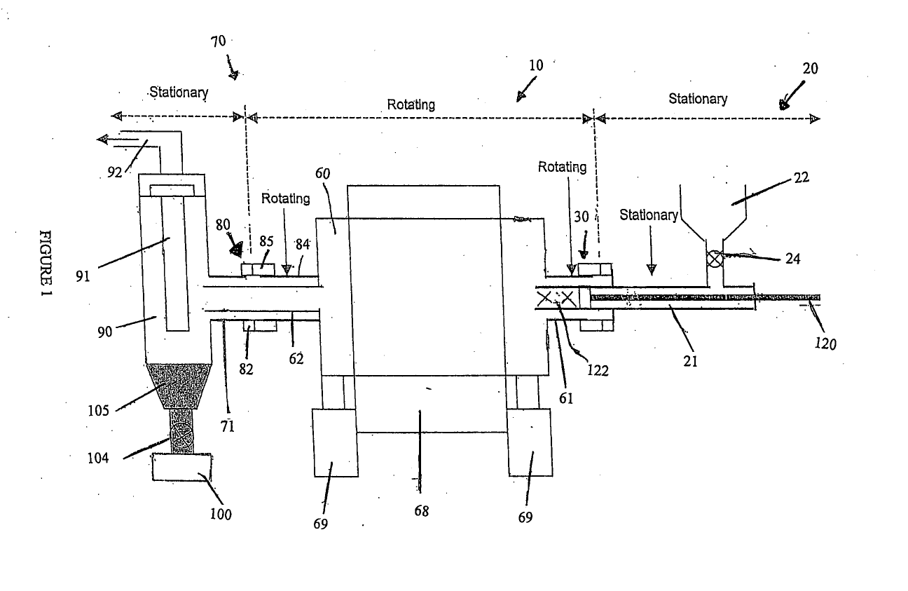

FIG. 1 shows a schematic view of a rotary kiln system in accordance with an embodiment of the present invention; and

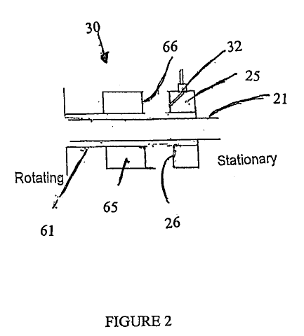

FIG. 2 is an enlarged and exploded view of part of the system of FIG. 1.

Referring to the drawings, a pyrolysis system 10 comprises a rotary kiln 60 connected between a stationary feed or inlet side 20 and a stationary discharge or outlet side 70.

The feed material which may be solid lumpy material, is fed to a stationary feed pipe 21 by means of a feeder 22, such as a vibratory feeder or a screw feeder, with a rotary valve 24 acting as a seal. Pipe 21 is connected in sealed manner to the stationary part 25 of a rotary joint mechanism 30 and passes through the rotating part 65 of the mechanism 30 and into the kiln 60. The rotating part 65 is fixedly mounted to a pipe 61 of the kiln 60, the pipe 61 having a larger diameter than feed pipe 21.

An exploded view of the rotary joint mechanism 30 is shown in FIG. 2. It will be appreciated that, in operation, annular end face 66 of rotating part 65 slides over annular end face 26 of stationary part 25 while maintaining a tight sealing engagement. The mechanism 30 is provided with a purge nipple 32 for the introduction of nitrogen or other inert gas. The nitrogen gas pressure on the rotary joint surfaces 26, 66 is permanently maintained higher than the pressure inside the kiln, thus preventing any escape of pyrolysis gas or any ingress of air into the kiln.

The pyrolysis kiln 60 is heated by a stationary external furnace 68 and is rotated by a drive mechanism indicated at 69.

At the outlet side of the kiln there is provided a rotary joint mechanism 80 similar to the above-described mechanism 30. In this case the stationary outlet pipe 71 is of larger diameter than the rotating exit pipe 62. The rotating part 85 of rotary joint mechanism 80 is mounted on a rotating pipe 84 which is fixed to kiln 60 and surrounds exit pipe 62. The stationary part 82 of mechanism 80 is mounted on outlet pipe 71.

Outlet pipe 71 is connected to a stationary drop out box 90 which incorporates a dust filter 91 connected to a gas outlet 92. At the bottom of the drop out box, a screw feeder 100 or other conveying mechanism removes the solid residue. The filter 91 may be of the type disclosed in international patent application PCT/GB2003/004561 (publication number WO 2004/037389) filed on 22 Oct. 2003 and entitled “Treatment of Fluids,” the contents of which are hereby incorporated by reference.

In use, the material to be pyrolysed, which may contain volatile components, is fed by feeder 22 through valve 24 into feed pipe 21, from where it passes to the kiln 60. It passes through the kiln at a predetermined speed, during which time it is completely pyrolysed. The material is removed from the kiln via exit pipe 62 which extends into drop out box 90. Emerging gases are filtered by filter 91 and dust-free gas emerges from the filter to be passed to outlet 92. The screw feeder 100 at the bottom of the drop out box 90 is operated at a speed which ensures that the level of the pyrolysed material 105 is controlled such that the material forms its own seal.

An advantage of the above-described arrangement is that it permits adequate sealing of the system to be maintained at all times, whether to prevent air entering the system or to prevent gases leaving it. In particular, it permits the use of an indirectly heated rotary vessel where the gas inside the vessel is kept at a positive pressure with no volatile components escaping from the vessel via the feed and discharge arrangements. A continuous throughput of material to be pyrolysed can be maintained without interruption.

Since the feed or discharge material passes through the rotary joint in a separate pipe, the feed or discharge material does not come into contact with the seal. Moreover, since pipe 21 and rotating exit pipe 62 extend into kiln 60 and drop box 90 respectively, material is discharged well away from the rotary joints.

Use of nitrogen (or other inert gas) to pressurise the seal to a higher pressure than the gas inside the kiln prevents the atmosphere inside the kiln coming into contact with the seal. The nitrogen fills the space between the feed or discharge pipe and the inside of the rotary joint, thereby preventing gas or dust coming into contact with the seal. This greatly reduces any wear on the seal as it is kept clean. Any wear in the seal is counteracted by an increased use of nitrogen to maintain the higher relative pressure, preventing gas from inside the kiln escaping into the environment as the seal wears.

The absence of dust in the pyrolysis gases at outlet 92 has the advantages that the gases are suitable for use in gas turbines, and can also be used to produce pyrolysis oil that is free of particulates, thus having a much higher value since it is suitable for use in “diesel” type and boiler type operations. Moreover, the absence of particulates precludes the reformation of dioxins in the gas or oil products.

Various modifications can be made to the above-described arrangement. For example, a double flap valve or other suitable valve may be employed instead of rotary valve 24. Alternatively, if the feed material is of a sufficiently plastic nature, it can be fed by a compressing screw or a hydraulic ramming device 120 so that the material forms a plug 122 in the feed pipe 21, the plug 122 forming its own seal.

Moreover, for feed material in the form of liquid or slurries, a supply pump may be connected directly to the feed pipe 21, with the pump providing the seal.

Thus, it will be noted that systems according to the present invention are suitable for processing many types of feed material, including plastics, shredder residue, municipal solid wastes, tyres, wood, coal, liquids and slurries etc.

Instead of relying on the material 105 to form its own seal, a rotary valve seal 104, or a double flap valve or other suitable valve, may be provided at the outlet side.

The rotary joint mechanism 30, 80 can be water-cooled. Where not required, the purging arrangement can be omitted. Only one of the rotary joint mechanisms may be as described above, for example where high sealing performance is required at only one of the inlet and outlet.

In another modification, the facing cylindrical surfaces of the stationary and rotating pipes, or parts attached thereto, constitute the sealing surfaces of the rotary joint mechanisms, so that the joint seals are each formed between a radially outwardly-facing convex cylindrical surface and a radially inwardly-facing concave surface.

The disclosures in United Kingdom patent application No. GB 0514282.3, from which this application claims priority, and in the abstract accompanying this application are incorporated herein by reference.

1. A system for pyrolysing material comprising a stationary inlet stage, a rotary kiln and a stationary outlet stage, the inlet stage being upstream of the kiln, the kiln being upstream of the outlet stage, wherein there is provided between the inlet stage and the rotary kiln and/or between the rotary kiln and the outlet stage a rotary joint mechanism comprising a face seal between a rotating surface of a first seal member fixed to the kiln and a stationary surface of a second seal member fixed to the respective stage.

2. A system as claimed in claim 1, wherein the sealing surfaces of the first and second seal members are annular.

3. A system as claimed in claim 1, wherein the seal members are attached to respective inlet and outlet pipes of the rotary joint mechanism.

4. A system as claimed in claim 1, wherein an upstream device comprises an outlet pipe which extends through an inlet pipe of larger diameter of a respective downstream device.

5. A system as claimed in claim 4, wherein the outlet pipe extends into the downstream device itself.

6. A system as claimed in claim 1, wherein the rotary joint mechanism incorporates a passageway for the introduction of an inert purging gas to prevent entry of air into the system and/or to prevent gases from leaving the system.

7. A system as claimed in claim 6, wherein the passageway extends to the sealing surface of the stationary seal member from another surface of the stationary seal member.

8. A system as claimed in claim 7, wherein the passageway extends from an outer cylindrical surface of the stationary seal member.

9. A system as claimed in claim 1, wherein the inlet stage is provided with a valve mechanism to constitute an inlet seal.

10. A system as claimed in claim 9, wherein the valve is mechanical sealing device such as a rotary valve or a double flap valve.

11. (canceled)

12. A system as claimed in claim 1, wherein an inlet seal is achieved by means of a pump connected to a feed pipe.

13. A system as claimed in claim 1, wherein the outlet stage comprises a filter for dust-laden gases leaving the kiln, the filtered gases passing to a gas outlet.

14. A pyrolysis process comprising:
feeding a material to be pyrolysed to the inlet side of a first rotary joint mechanism incorporating an inlet sealing arrangement,
passing the material through the first rotary joint mechanism into a rotary kiln,
pyrolysing the material in the rotary kiln, and
passing the material through a second rotary joint mechanism incorporating an outlet sealing arrangement to the outlet side thereof.

15. A process as claimed in claim 14, wherein a system comprising a stationary inlet stage, a rotary kiln and a stationary outlet stage, the inlet stage being upstream of the kiln, the kiln being upstream of the outlet stage, wherein there is provided between the inlet stage and the rotary kiln and/or between the rotary kiln and the outlet stage a rotary joint mechanism comprising a face seal between a rotating surface of a first seal member fixed to the kiln and a stationary surface of a second seal member fixed to the respective stage, is used in the process.

16. A process as claimed in claim 14, wherein the feeding step includes feeding the material through a valve mechanism, such as a rotary valve or double flap valve, as an inlet seal.

17. (canceled)

18. A process as claimed in claim 14, wherein the feeding step includes using pumping means to feed the material through the first rotary joint mechanism, the pumping means acting as an inlet seal.

19. A process as claimed in claim 14, wherein the feeding step comprises using delivery means to feed the material through the first rotary joint mechanism to form a plug of material which acts as an input seal.

20. A process as claimed in claim 19, wherein the delivery means is a compressor screw, a hydraulic ramming device, or an extrusion device in an inlet pipe.

21. A process as claimed in claim 14, further including the step of purging the rotary joint mechanism with an inert gas.

22. (canceled)

23. A process as claimed in claim 14, further including the step of filtering dust-laden gases emerging from the kiln.
